(19) United States
(12) Patent Application Publication
(10) Pub. No.: US 2009/0210255 A1
(43) Pub. Date: Aug. 20, 2009

(54) Efficient Automated System for Processing Refill

(75) Inventor: Mauricio A. Leon, San Diego, CA (US)

Correspondence Address: WINTHROP D. CHILDERS, 9855 FOX VALLEY WAY, SAN DIEGO, CA, 92127, US

(73) Assignee: LIFE-FILE, LLC, SAN DIEGO, CA (US)

(21) Appl. No.: 12/372,713

(22) Filed: Feb. 17, 2009

Related U.S. Application Data
(60) Provisional application No. 61/029,921, filed on Feb. 20, 2008.

(51) Int. Cl. G06Q 50/00; G06F 15/16

(52) U.S. Cl. 705/3; 705/2; 709/204

(57) ABSTRACT

The present invention concerns an efficient method for processing a prescription wherein a computer system receives an electronic mail message from a patient system. The electronic mail message includes an electronic mail address having a leading string of characters that are indicative of the prescription. The computer system processes the leading string of characters to identify and process the prescription.

### RELATED APPLICATIONS

This non-provisional application claims priority to U.S. Provisional Application Ser. No. 61/029,921, Entitled “Efficient Automated System for Processing Refill” by Mauricio A. Leon, filed on Feb. 20, 2008, incorporated herein by reference under the benefit of U.S.C. 119(e).

### FIELD OF THE INVENTION

The present invention concerns methods for patients to order prescription medications and devices.

### BACKGROUND

Prescription refilling is performed by providing a prescription number (otherwise referred to as an Rx number) to a pharmacy by telephone or in person. A web interface is another way to order refills. However this often requires that a patient log on to a pharmacy system web site with the normal inconveniences of filling out forms and remembering passwords. Newer more convenient methodologies are desirable.

### BRIEF DESCRIPTION OF THE DRAWINGS

FIG. 1 is a block diagram of a network utilizing the present invention.

FIG. 2 is a flow chart representation used to depict multiple embodiments of the present invention.

### DETAILED DESCRIPTION OF THE PREFERRED EMBODIMENT

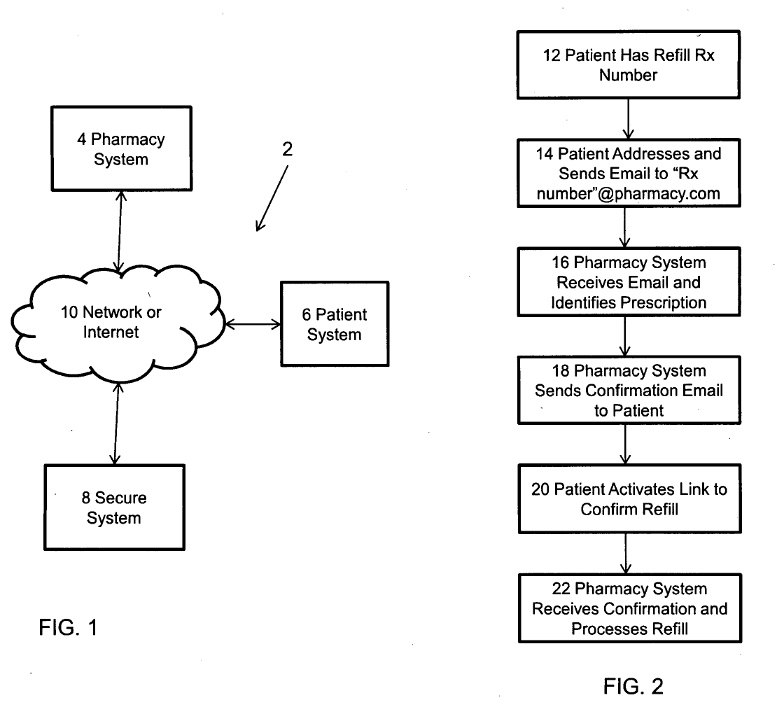

A system 2 utilizing the present invention is depicted in FIG. 1. A pharmacy system 4, a patient system 6, and a secure system 8 are coupled to each other via the internet 10. The pharmacy system 4 is an IT (information technology) system utilized by a pharmacy. The patient system 6 is a device capable of sending and receiving electronic mail messages used by a patient or patient's guardian. Examples of patient system 6 include a desktop computer, a laptop computer, a portable computer, a notebook computer, a PDA (personal digital assistant), or a cellular phone to name a few examples. The secure system is an IT system that may be used to facilitate transactions between patient systems 6 and pharmacy systems 4 and may be used to act on behalf of pharmacy system 4.

A flow chart representation of an exemplary method of the present invention is depicted in FIG. 2. According to 12, a patient has a prescription and an accompanying prescription or Rx number. According to step 14, the patient sends an electronic mail “e-mail” message to the pharmacy system. The electronic mail message includes an outgoing address having a string of leading characters that are indicative of the prescription. In a preferred embodiment, the string of leading characters is the numerical prescription number or a prescription code that may include numbers and other characters. In some embodiments, prescription numbers are numerical numbers that are six or seven characters long.

Thus, the outgoing address from the patient system may be of the form “Rx number”@“pharmacy name”.com wherein “Rx number” is the prescription number that, in an exemplary embodiment, is a six or seven digit number. Suppose that the prescription number is 123456 and the pharmacy has a web address of www.savemed.com. Then, the outgoing email address may be 123456@savemed.com. If the pharmacy is known as “CVS”, then the outgoing email address may be 123456@cvs.com.

When the pharmacy system receives the electronic mail message from the patient system, the pharmacy system processes the string of characters to identify prescription information that is indicative of the prescription according to 16. The prescription information may also be indicative of an email address for the patient.

Once the pharmacy system identifies the prescription, the pharmacy system 4 sends a confirmation electronic mail message to the patient system 6 according to 18. The confirmation electronic mail message contains a web link. When the patient activates the link according to 20, the pharmacy system 4 receives an indication that the web link was activated also according to 20. The web link activation confirms the refill order and then the pharmacy system 4 processes a prescription refill for the prescription number according to 22.

A first alternative embodiment of the present invention allows a patient to order multiple prescriptions with a single electronic mail message. Referring back to FIG. 2 and element 12, the patient has multiple Rx numbers associated with multiple prescriptions. According to 14, the patient sends an electronic mail message to the pharmacy system. The electronic mail message includes an outgoing address having a string of leading characters that are indicative of one of the multiple prescription numbers.

The system receives the electronic mail message and processes the string of leading characters according to 16. Identifying the prescription, the system also identifies the patient and identifies other prescriptions for which the patient may want to order refills. Suppose in this example the patient has three such prescriptions including prescription numbers 123456, 654321, and 1212121.

Once the pharmacy system identifies the prescriptions, the pharmacy system 4 sends a confirmation electronic mail message to the patient system 6 according to 18. The confirmation electronic mail message contains at least one web link. The message may include something like the following:

Please click here to confirm refill for Rx 123456

Please click here to confirm refill for Rx 654321

Please click here to confirm refill for Rx 1212121

Please click here to confirm refill for all your medications

When the patient activates a web link according to 20, the pharmacy system 4 receives an indication that the web link was activated also according to 20. The web link activation confirms the refill order and then the pharmacy system 4 processes one or more prescription refills for the prescription number according to 22 depending upon what web link or links were activated.

A second alternative embodiment of the present invention allows a patient to order refills for multiple prescriptions with a single electronic mail message. Referring back to FIG. 2 and element 12, the patient has multiple Rx numbers associated with multiple prescriptions: 123456, 654321, and 1212121. According to 14, the patient sends an electronic mail message to the pharmacy system. The electronic mail message includes an outgoing address having a string of leading characters that are indicative of multiple prescription numbers. In a preferred embodiment, the string of leading characters contains the numerical prescription numbers separated by characters such as periods “.” or dashes “-” or commas “,” or the like. As an example, suppose the prescription numbers are 123456, and 654321, and 1212121. The patient can use the following as the outgoing electronic mail address for step 14: 123456-654321-1212121@savemed.com for example.

When the pharmacy system receives this electronic mail message, it processes the leading string of characters and identifies three separate prescriptions according to step 16. Once the pharmacy system identifies the prescriptions, the pharmacy system 4 sends a confirmation electronic mail message to the patient system 6 according to 18. The confirmation electronic mail message contains at least one web link.

When the patient activates a web link according to 20, the pharmacy system 4 receives an indication that the web link was activated also according to 20. The web link activation confirms the refill order and then the pharmacy system 4 processes one or more prescription refills for the prescription number according to 22.

Note that method steps 16, 18, and 22, and other applicable processes may be performed by pharmacy system 4, secure system 8, or a combination of pharmacy system 4 and secure system 8. The electronic mail correspondence and web link correspondence may be between patient system 6 and pharmacy system 4, or patient system 6 and secure system 8, or any combination thereof.

What we claim is:

1. An automated method for filling a prescription for a patient comprising:
receiving an electronic mail message from a patient system, the electronic mail message including an electronic mail address having a string of leading characters that are indicative of the prescription;
processing the leading string of characters to identify prescription information indicative of the prescription; and
processing the prescription.

2. The method of claim 1 wherein the string of leading characters is indicative of multiple prescriptions.

4. The method of claim 1 wherein the string of leading characters is a numerical prescription number.

5. The method of claim 1 wherein the string of leading characters is a series of numerical prescription numbers.

6. The method of claim 1 further comprising:
sending a confirmation electronic mail message to the patient system before processing the prescription.

7. The method of claim 6 wherein the confirmation electronic mail message contains a web link and further comprising:
receiving an indication that the web link has been activated before processing the prescription.

8. The method of claim 6 wherein the confirmation electronic message contains multiple web links and further comprising:
receiving an indication that one or more of the multiple web links have been activated before processing the prescription.

9. The method of claim 1 further comprising identifying all prescriptions for the patient for which refills may be provided.

10. The method of claim 9 further comprising sending a confirmation message to the patient system indicative of all prescriptions for which refills are available for the patient.

11. An automated system for processing prescription refills for a patient comprising: a secure system configured to:
receive an electronic message from a patient system;
read a leading character string of an address for the electronic message;
utilize a database to identify a prescription based upon the leading character string; and
process a refill for the prescription.

12. The automated system of claim 11 wherein the secure system is configured to send a confirmation message to the patient system before processing the refill.

13. The automated system of claim 12 wherein the confirmation message contains a web link, the secure system is configured to receive information indicative of an activation of the web link before processing the refill.

14. The automated system of claim 12 wherein the confirmation message contains a plurality of web links each corresponding to a different prescription, the secure system is configured to process a particular prescription in response the activation of a web link corresponding to the particular prescription.

15. The automated system of claim 12 wherein the confirmation message includes a list of all prescriptions for which refills are available.

16. The automated system of claim 11 wherein the automated system is configured to process a plurality of prescription refills in response to reading the leading character string.

17. A method of processing a refill order for a prescription for a patient comprising:
receiving an electronic mail message from a patient system, the electronic mail message includes an address having a leading string of characters that include the numerical digits of at least one prescription number for the prescription;
identifying the prescription in response to reading the leading string of characters;
sending a confirmation electronic message to the patient system, the confirmation electronic message containing a web link;
receiving an indication that the web link has been activated thereby confirming a request for the refill order; and
processing the refill order.

18. The method of 17 wherein the leading string of characters includes the numerical digits of a plurality of prescription numbers.

19. The method of 17 wherein confirmation electronic message contains a listing of multiple prescriptions for the patient.

20. The method of claim 17 wherein the electronic message contains multiple web links each corresponding to a different prescription.
